(19) United States
(12) Patent Application Publication
(10) Pub. No.: US 2020/0236344 A1
(43) Pub. Date: Jul. 23, 2020

(54) Enhanced System for Lowering and Guiding 3-D Camera Apparatus

(71) Applicant: John Hubbard, Hampstead, NH (US)

(72) Inventor: John Hubbard, Hampstead, NH (US)

(21) Appl. No.: 16/841,163

(22) Filed: Apr. 6, 2020

Related U.S. Application Data
(63) Continuation-in-part of application No. 15/973,119, filed on May 7, 2018, now Pat. No. 10,616,456.
(60) Provisional application No. 62/501,955, filed on May 5, 2017.
(60) Provisional application No. 62/512,390, filed on May 30, 2017.

(51) Int. Cl. H04N 13/30; G03B 35/04

(52) U.S. Cl. CPC H04N 13/30; H04N 2013/405; H04N 2213/001; G03B 35/04

(57) ABSTRACT

An apparatus comprising of a device to enclose a durable, data collecting camera in an upright position, as to be put into subterranean environment, such as a manhole, and utilizing sensors and lights to detail the information of the manhole which it is lowered into. It is attached to a metal arm that may be connected either to an automobile or tripod for stability. An application may be used to view this data and the camera itself has the ability to move 360 degrees while attached to a metal arm. This ensures the camera is kept in an upright position, which is particularly useful while using the Matterport® ® Pro 1/Pro 2 cameras.

### CROSS REFERENCE TO RELATED APPLICATION

This application is a Continuation-in-part application and claims priority to and takes the benefit of U.S. patent application Ser. No. 15/973,119 filed on May 7, 2018, which in turn takes the benefit of U.S. Provisional Patent Application Ser. No. 62/501,955 filed on May 5, 2017 and U.S. Provisional Patent Application Ser. No. 62/512,390 filed on 5 May 30, 2017, the contents of which both applications are incorporated by reference.

### BACKGROUND OF THE INVENTION

### Field of the Invention

The present Utility Model refers to a device to affix a Matterport® Pro 1/Pro 2 camera to a metal arm to be lowered into a manhole to collect data while maintaining the camera in an upright position. This allows for effectively doubling the camera's capturable spaces and provides the option for being attached to the back of a truck or using a tripod over the manhole to do so.

### Description of the Related Art

Within the prior art in the subject there are various cameras and extending arms to allow for a camera to reach depths below the ground in a manhole.

Amongst the prior art, one system illustrates a robotic arm and method for the treatment of system of conduits and lateral sub-conduits comprising a remotely controlled robotic vehicle which navigates main conduits which delivers a series of tools to locations within the conduit.

Another system illustrates an autonomous inspector mobile platform robot that is used to inspect a pipe or network of pipes including a locomotion device that enables the device to autonomously progress through the pipe.

Another system illustrates one or more monitoring devices, positioned in sewer manholes, storm drains, etc., and a remote monitoring station that communicates wirelessly therewith.

Another system illustrates a lateral inspection television camera into the lateral pipeline from a main sewer pipeline by remote control which is stored in a generally cylindrical launcher mechanism having a camera port opening through which the lateral camera may be projected and retracted.

Another system illustrates input equipment to an enclosure to provide a platform and means for sensing environmental or process parameters inside or around the enclosure and wirelessly transmitting those parameters to a remote location.

This present utility model is different from the existing prior art, because, among the most remarkable advantages of this device is its dual capabilities of being attached to the back of an automobile, or as a stand-alone device using a tripod over a manhole cover, using a winch to lower the camera, as secured in an encasing while remaining upright, into a manhole with assistance via sensors as to gather data and to lower the camera in a controlled fashion.

It is worth mentioning that this device is particularly compatible with the Matterport® Pro 1/Pro 2, Licta BLK, and Phara cameras that must remain upright in order to properly function and collect data.

### SUMMARY OF THE INVENTION

The reason for this present utility model is to provide a means for deploying a Matterport® Pro 1/Pro 2 camera in a downward oriented direction while remaining in its natural upright position. At present, Matterport® Pro 1/Pro 2 camera can only operate upside right whilst mounted atop a fixed position such as a tripod. Using a system consisting of a frame, bearing, strut and camera “chuck.” GibbetMount™ deploys the camera in a downward direction while maintaining its own freely rotating action.

There is no other design which accomplishes what GibbetMount™ does using a Matterport® Pro 1/Pro 2 camera. The only way that a Matterport® camera can function at present is atop a fixed surface which remains stable or goes up. However, this device allows the Matterport® Pro 1/Pro 2 camera to remain upright while going below surface level in manholes and the like to collect important data.

Moreover, this device solves the issues of using a LIDAR (laser) scanner, such as a Leica BLK, which has inherent problems when mounted upside down. Therefore, this device provides the best results possible for collecting data in subterarrian settings.

The operator of this device may determine the device's location and/or height via the LED Ring atop the device which displays information using a predetermined color coded information translating into the distance from the ground. The Gibbet Mount™ forward facing LED lighting system illuminates objects within the camera's own field of vision-augmentation using its own UV Sensor capturing capabilities. The camera will also be mounted on a tripod and is controllable via WIFI with the Matterport® Capture Application.

Lastly, as the GibbetMount™ transfers that rotational energy to above the camera via the Strut/Chuck system, it functions normally in its upright position while being deployed in a downward facing direction.

### BRIEF DESCRIPTION OF THE DRAWINGS

FIG. 1 illustrates the ultrasonic sensor for housing the camera from the bottom view.

FIG. 2 illustrates the ultrasonic sensor for housing the camera with the components separated from one another.

FIG. 3 illustrates the ultrasonic sensor for housing the camera with the bearing mount detached.

FIG. 4 illustrates the ultrasonic sensor for housing the camera from the top view.

FIG. 5 illustrates the ultrasonic sensor for housing the camera from the side view with the electronic components detached from the device.

FIG. 6 illustrates the ultrasonic sensor for housing the camera from the back view with the bearing cover and electronics within the device.

FIG. 7 illustrates the ultrasonic sensor for housing the camera with bearing mount attached.

FIG. 8 illustrates the battery compartment for the ultrasonic sensor for housing the camera.

FIG. 9 illustrates the battery compartment with the battery and connector for the ultrasonic sensor for housing the camera.

FIG. 10 illustrates the ultrasonic sensor for housing the camera with battery compartment from the right rear view.

FIG. 11 illustrates the ultrasonic sensor for housing the camera from the top with an LED ring.

FIG. 12 illustrates the ultrasonic sensor for housing the camera and battery from the right side.

FIG. 13 illustrates the ultrasonic sensor for housing the camera and battery from the left side view.

FIG. 14 illustrates the ultrasonic sensor for housing the camera and battery from the bottom view.

FIG. 15 illustrates the ultrasonic sensor for housing the camera and battery from the top view.

FIG. 16 illustrates the ultrasonic sensor for housing the camera and battery from the front view.

FIG. 17 illustrates the ultrasonic sensor for housing the camera and battery from the rear view.

FIG. 18 illustrates the Gibbet Mount camera from the front view.

FIG. 19 illustrates the metal arm subcam for the camera fully extended.

FIG. 20 illustrates the metal arm subcam for the camera folded.

FIG. 21 illustrates the metal arm subcam and camera attached to be released downwards.

FIG. 22 illustrates the metal arm subcam and camera attached to the back of an automobile for going down manholes.

FIG. 23 illustrates a metal tripod for holding the camera.

FIG. 24 illustrates a metal tripod and the winch.

FIG. 25 illustrates the metal tripod and winch to propel the camera into a manhole.

FIG. 26 illustrates the winch at the top of the tripod.

FIG. 27 illustrates the winch separate from the tripod.

### DETAILED DESCRIPTION OF THE SEVERAL EMBODIMENTS

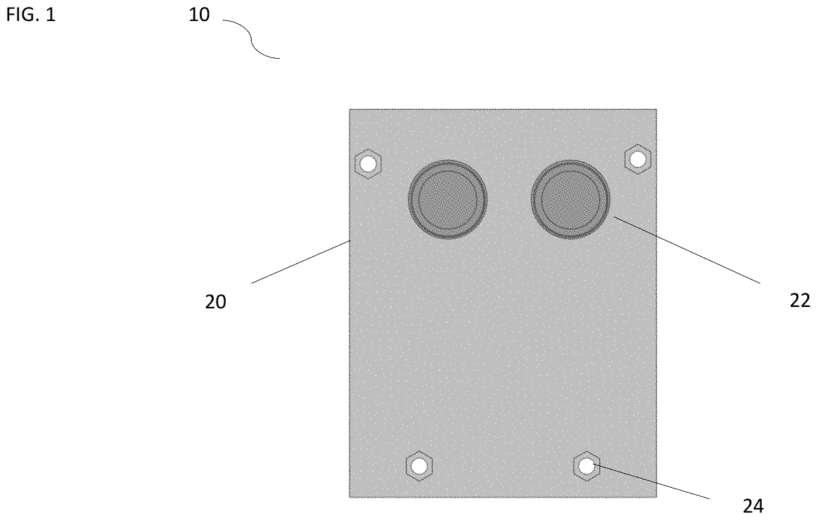

FIG. 1 illustrates the ultrasonic housing container 10 for the camera from the bottom view wherein main body of the device 20 maintains the sensors 22 are secured to the device on either side and through screws via the screw holes 24 indicated on the device.

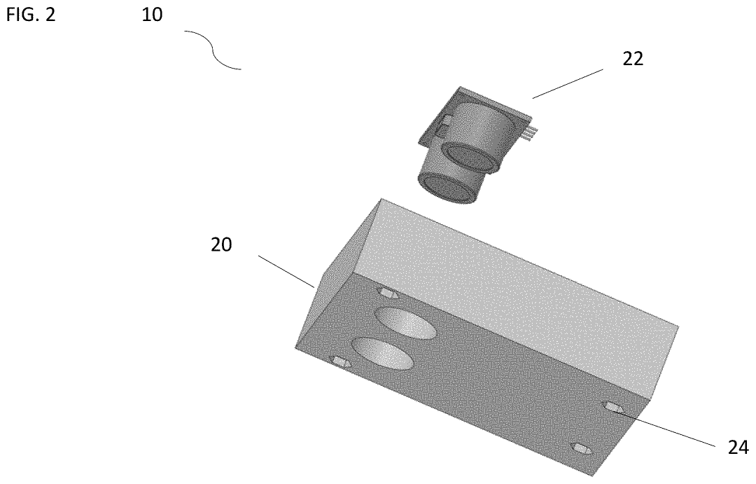

FIG. 2 illustrates the ultrasonic housing container 10 for the camera from the sideview wherein the main body of the device 20 and the sensors 22 are separated and the holes for the screws 24 are open.

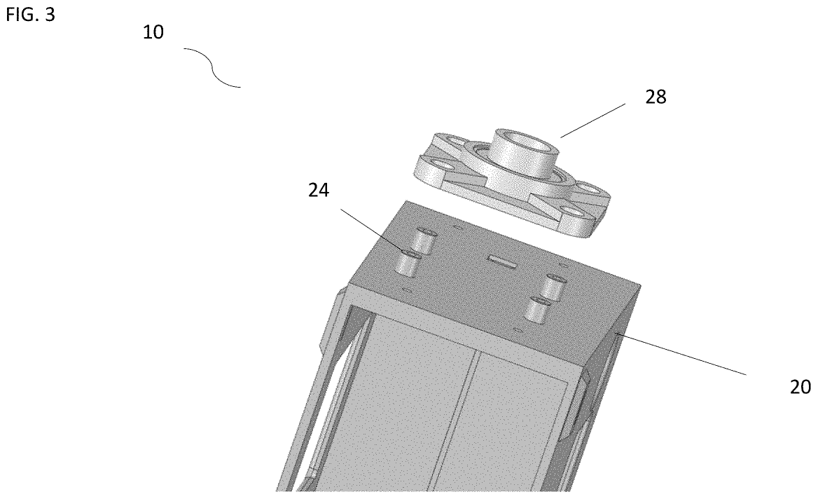

FIG. 3 illustrates the ultrasonic housing container 10 for the camera wherein the main body of the device 20 displayed the tubes for which the mount to hold the device to the shaft 28 is detached from the body of the device.

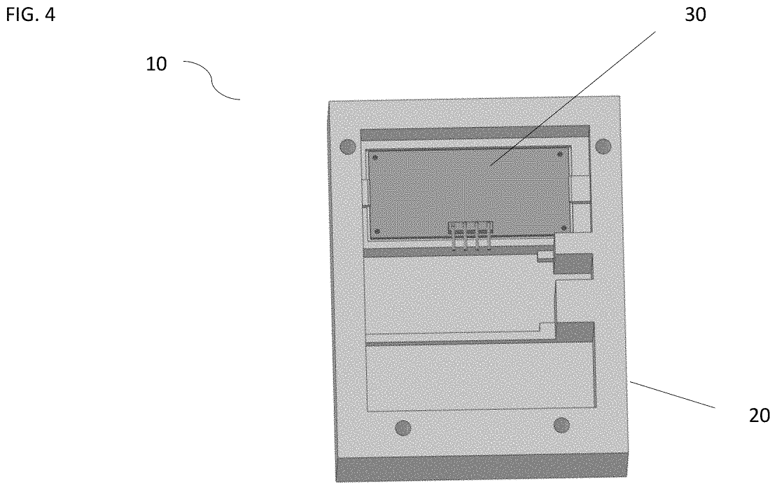

FIG. 4 illustrates the ultrasonic housing container 10 for the camera wherein the main body of the device 20 is viewed from the top displaying the cover 30 for the electronics within the device.

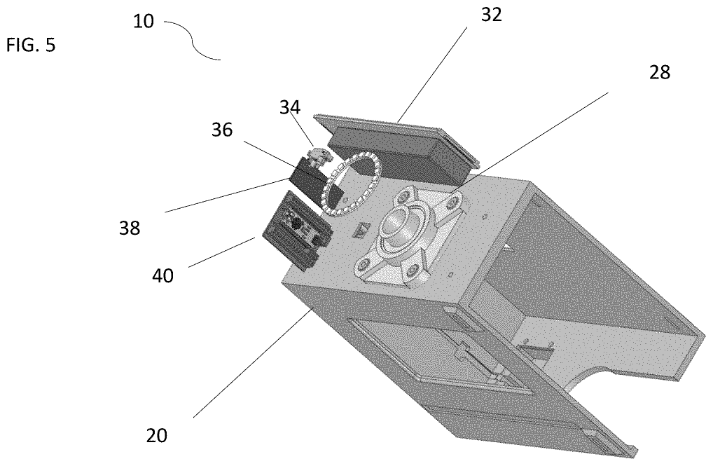

FIG. 5 illustrates the ultrasonic housing container 10 for the camera wherein the main body of the device 20 displays the mount to hold the device to the metal tube 28, the battery 32, the connector 34, the LED light 36, the plate 38 and the electronics chip 40.

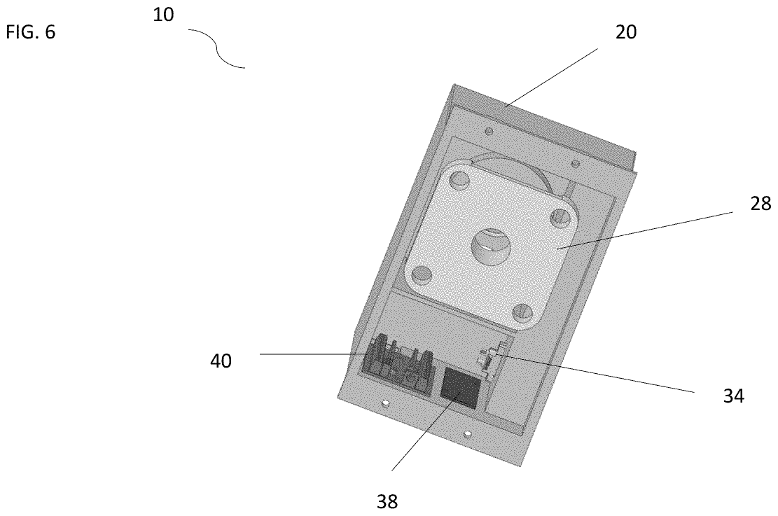

FIG. 6 illustrates the ultrasonic housing container 10 for the camera wherein the main body of the device 20 bears the cover for the electronics as displaying the bottom of the mount to put the shaft through 28 from the bottom, the connector 34, the plate 38, and the electronics chip 40 from inside the device.

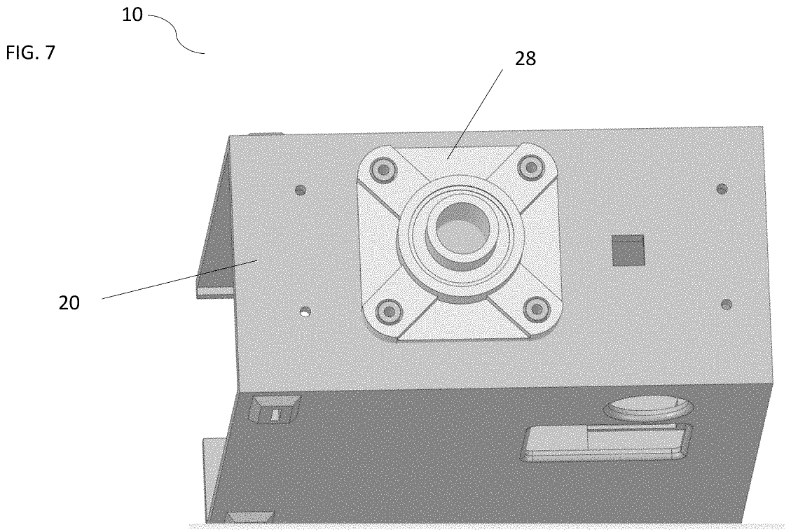

FIG. 7 illustrates the ultrasonic housing container 10 for the camera wherein the main body of the device 20 displays the mount 28 from the outside of the device.

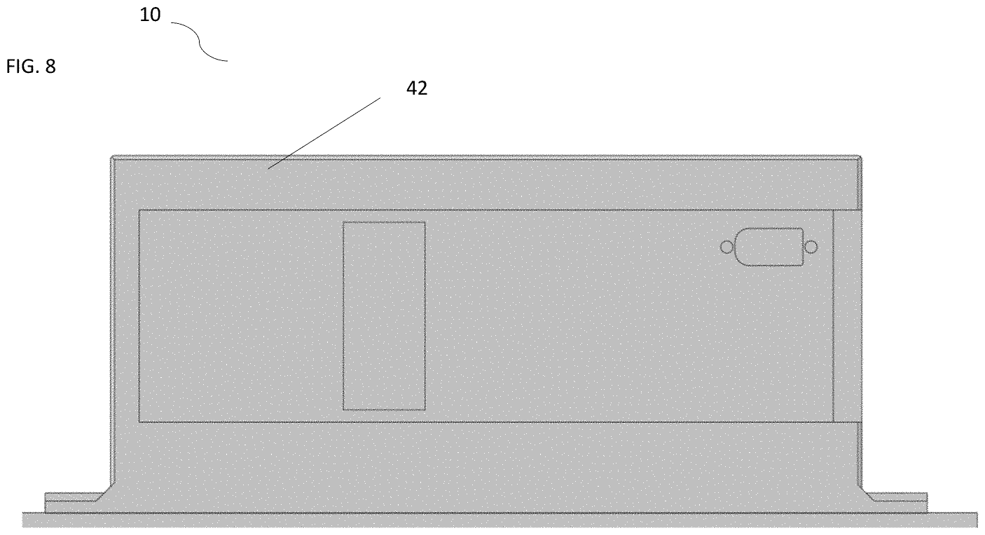

FIG. 8 illustrates the ultrasonic housing container 10 for the camera wherein the battery compartment 42 is displayed from the side.

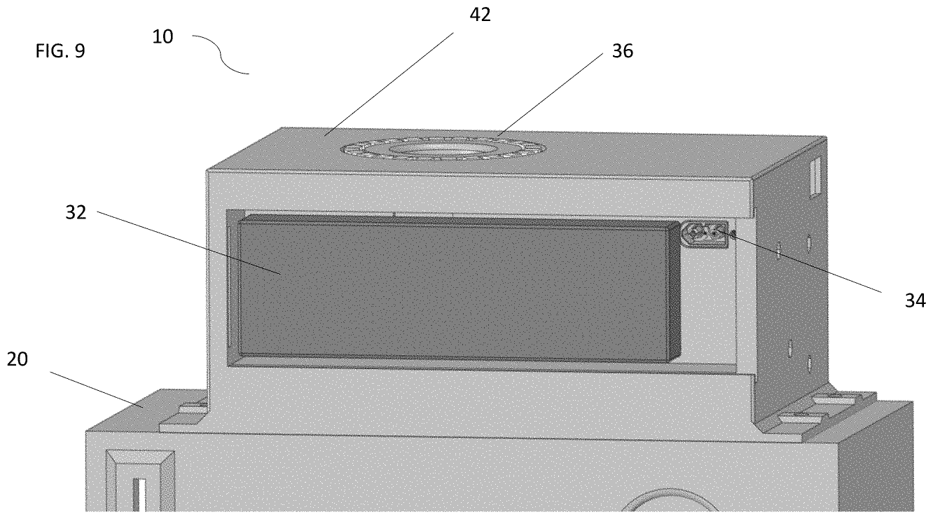

FIG. 9 illustrates the ultrasonic housing container 10 for the camera wherein the battery compartment 42 displays the LED light 36 on top of the compartment, the battery 32 within the device, the connector 34, and the main body of the device 20.

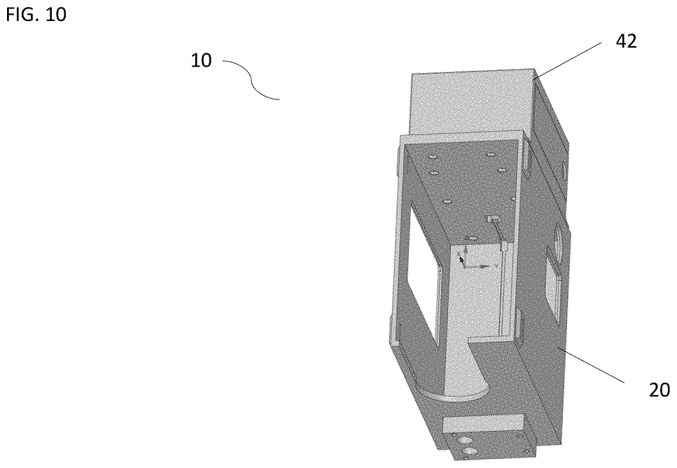

FIG. 10 illustrates the ultrasonic housing container 10 with the main body of the device 20 attached to the battery compartment 42 from the rear right view.

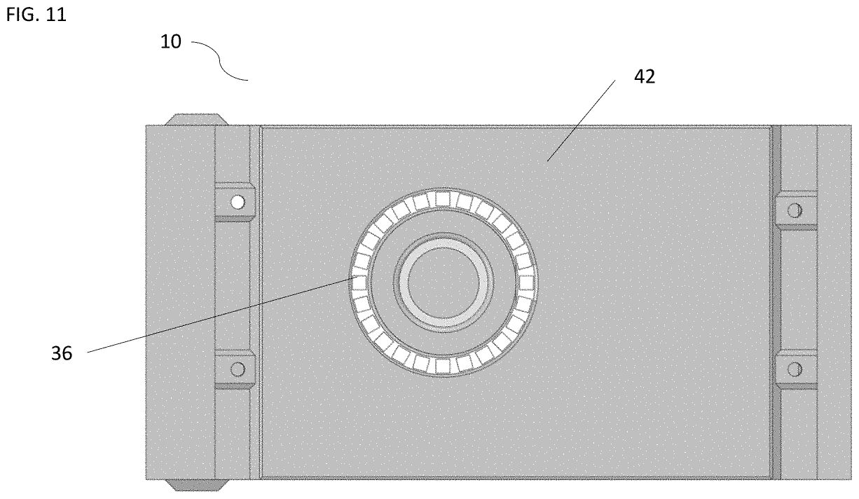

FIG. 11 illustrates the ultrasonic housing container 10 from the top view of the battery compartment 42 with the LED light 36.

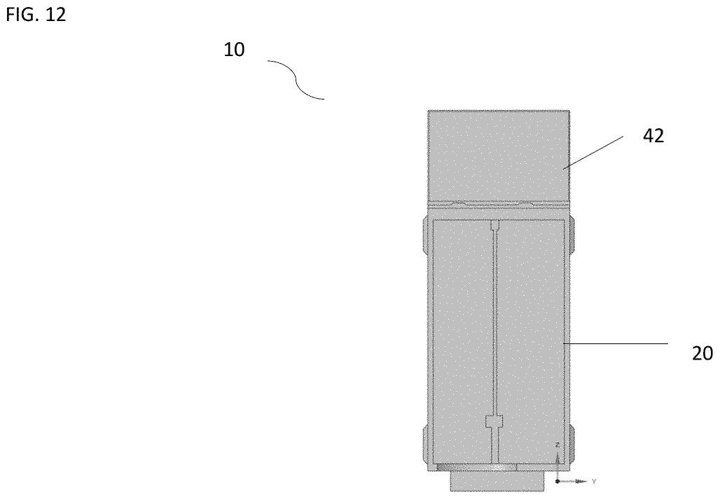

FIG. 12 illustrates the ultrasonic housing container 10 from the ride side view wherein the battery compartment 42 attached to the main body of the device 20.

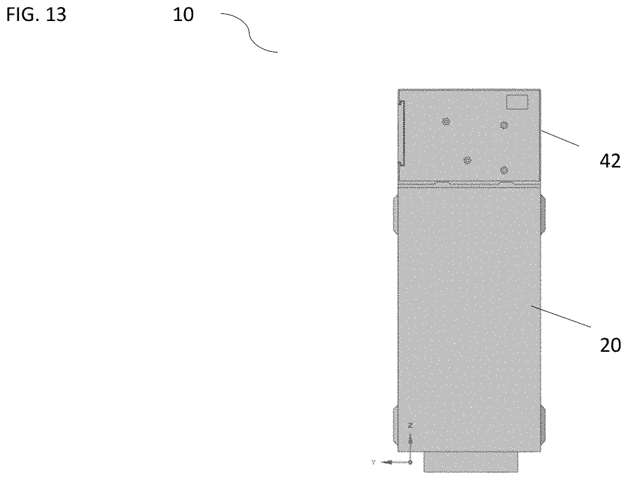

FIG. 13 illustrates the ultrasonic housing container 10 from the left side view wherein the battery compartment 42 is attached to the main body of the device 20.

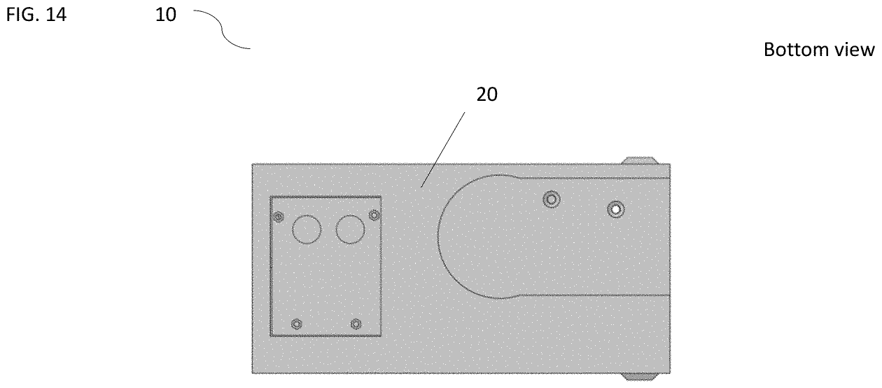

FIG. 14 illustrates the ultrasonic housing container 10 from the bottom view of the main body of the device 20.

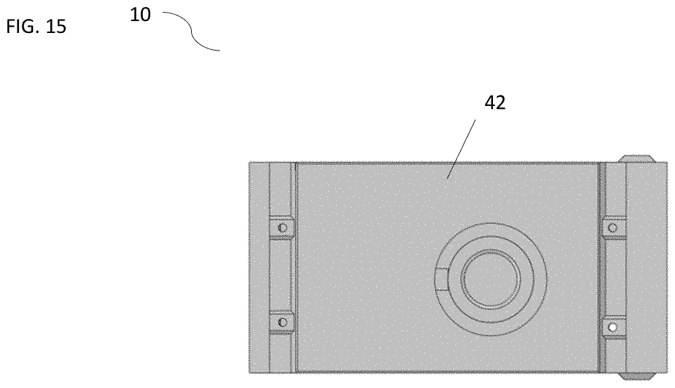

FIG. 15 illustrates the ultrasonic housing container 10 from the top view of the battery compartment 42.

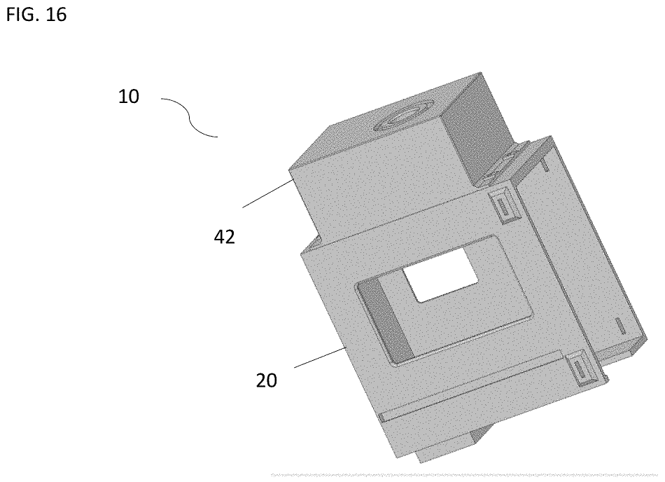

FIG. 16 illustrates the ultrasonic housing container 10 from the front view wherein the battery compartment 42 is displayed attached to and on top of the main body of the device 20.

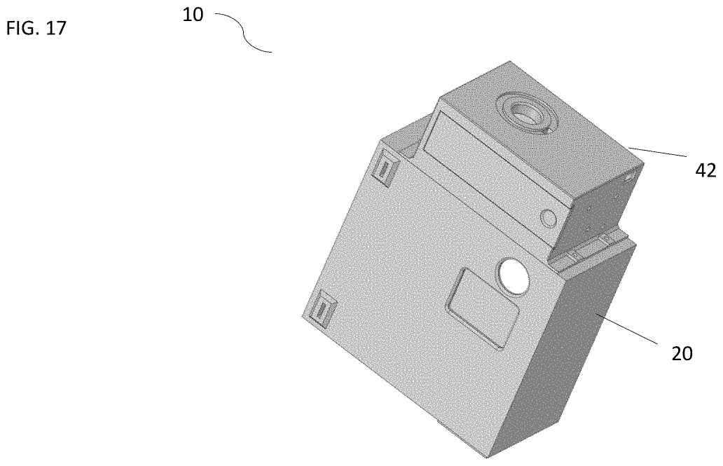

FIG. 17 illustrates the ultrasonic housing container 10 from the rear view wherein the battery compartment 42 is displayed attached to and on top of the main body of the device 20.

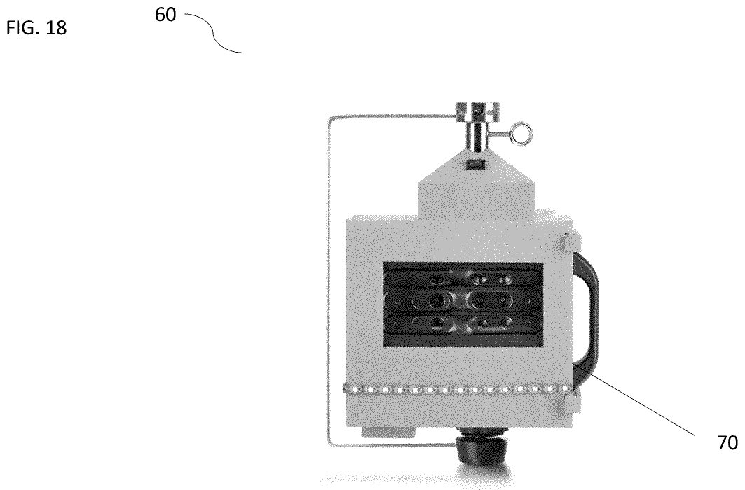

FIG. 18 illustrates one embodiment 60 wherein the subcam metal arm 70 for extending the camera downwards is used to attach to the camera while maintaining it upright.

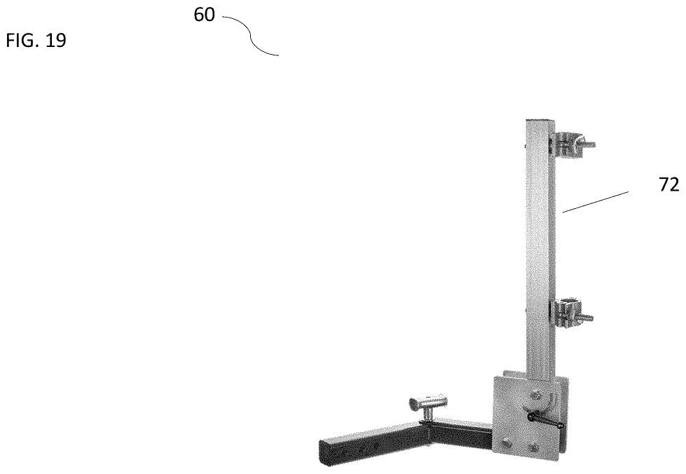

FIG. 19 illustrates one embodiment 60 wherein the subcam metal arm 70 for extending the camera downwards is folded for storage purposes.

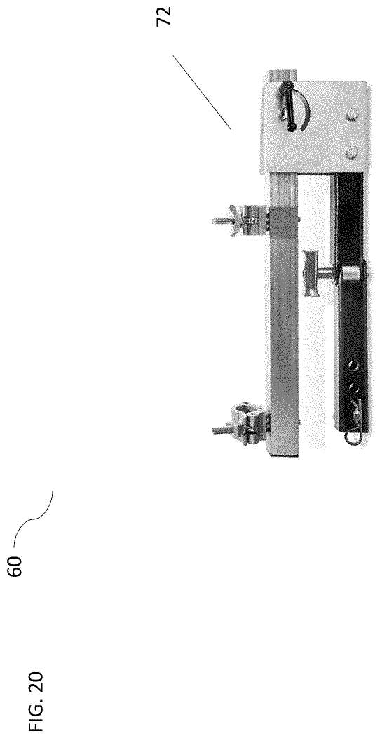

FIG. 20 illustrates one embodiment 60 wherein the subcam metal arm 72 is attached to a metal shaft 74 to hold the camera 70 in an upright position while submerging it into a manhole.

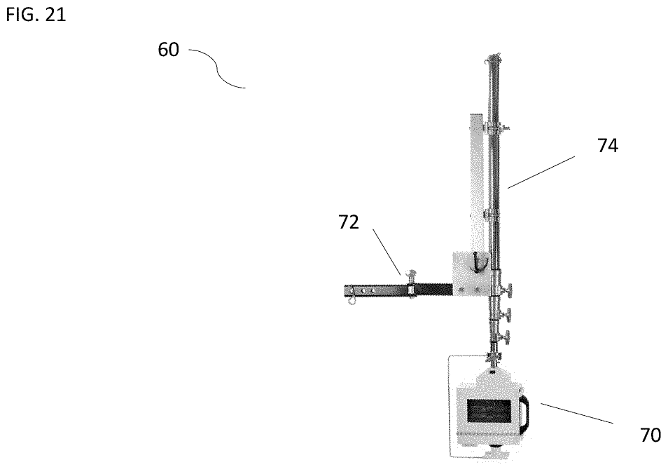

FIG. 21 illustrates one embodiment 60 wherein the subcam metal arm 72 is attached to a metal shaft 74 to hold the camera 70 in an upright position while submerging it into a manhole while attached to a car and using a winch 76 to lower the camera into the manhole.

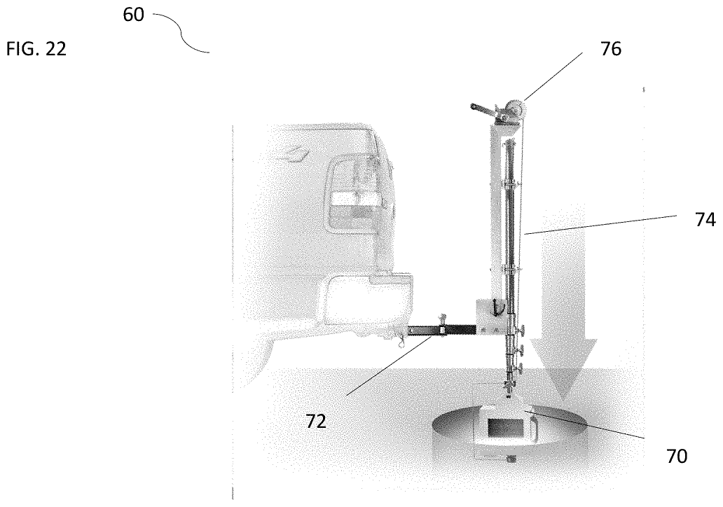

FIG. 22 illustrates one embodiment 60 wherein a metal tripod 78 is used in place of the subcam metal arm 72 allowing the metal shaft 72 to run through the tripod 78, resting above a manhole.

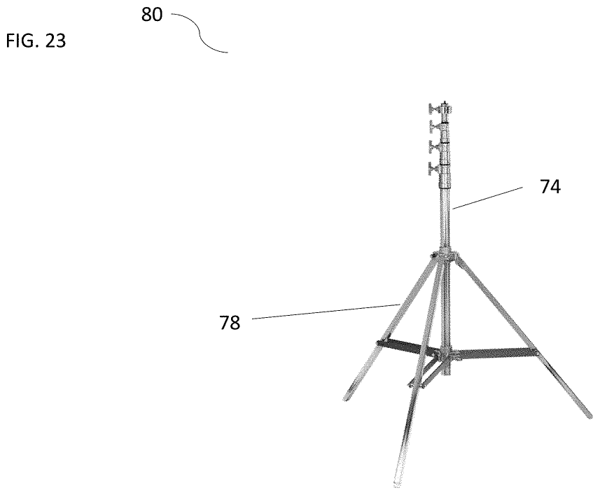

FIG. 23 illustrates one embodiment 60 wherein a metal tripod 78 is suspended above a manhole while using a metal shaft 74 that may be attached to a camera.

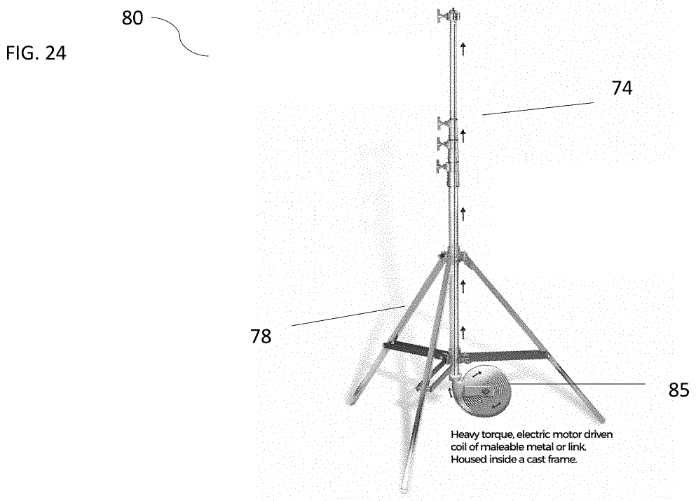

FIG. 24 illustrates one embodiment 60 wherein a metal tripod 78 is used in place of the subcam metal arm 72 allowing the metal shaft 72 to run through the tripod, resting above a manhole while using a catheterized winch system 85 comprised of an electric motor driven coil of malleable metal or link housed inside a cast frame.

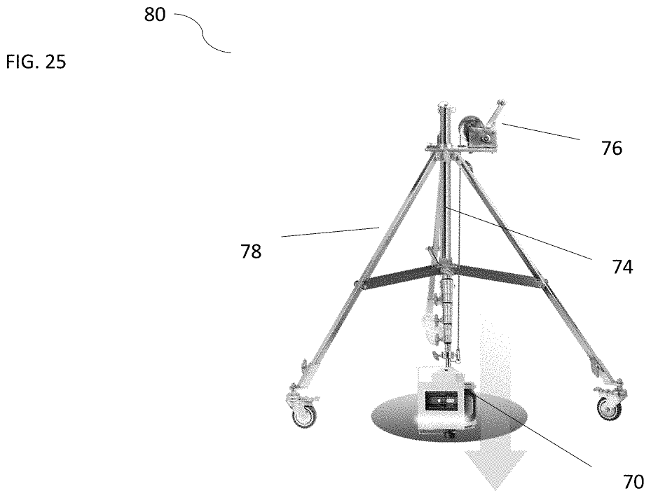

FIG. 25 illustrates one embodiment 60 wherein the winch 76 attached to the metal shaft 74 and the metal tripod 78 is used to lower the camera 70 into the manhole is displayed.

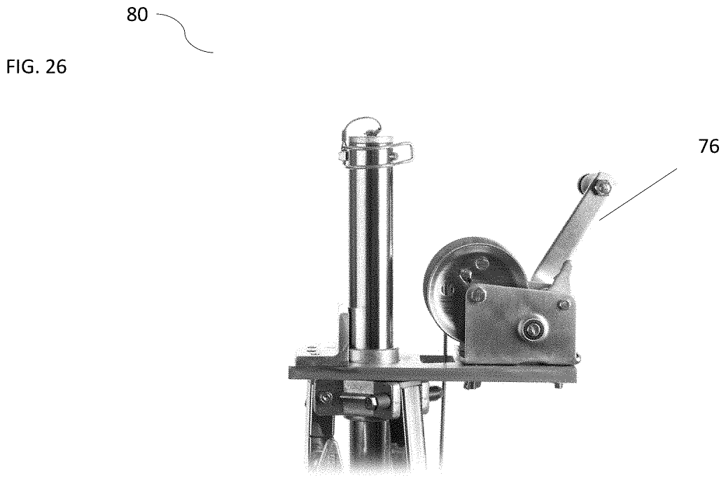

FIG. 26 illustrates one embodiment 60 wherein the winch 76 used to lower the camera 70 into the manhole is detailed more closely as to display the crank 82, the cable and hook to attach to the camera and lower it 84, and the metal frame with retaining wall and a hole for the wire to be fed through 86.

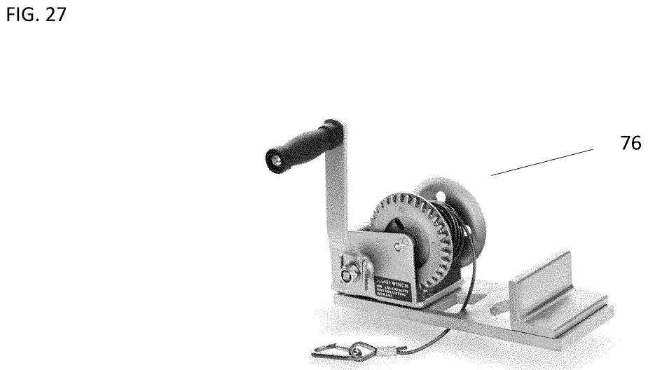

FIG. 27 illustrates the winch separate from the tripod.

What is claimed is:

1. A system for lowering and guiding a 3D camera apparatus comprising:
a pole mechanism;
a top mount mechanism;
a base mount mechanism;
at least one cage bar apparatus;
a rotational apparatus;
a receiving mechanism disposed to couple the rotational apparatus with a rotating member of the 3D camera apparatus;
a tripod apparatus; and
a catheterized winch system comprising an electric motor driven coil of malleable metal and a link housed inside a cast frame.
